(19) United States
(12) Patent Application Publication
(10) Pub. No.: US 2015/0260928 A1
(43) Pub. Date: Sep. 17, 2015

(54) FIBER OPTIC EPOXY CUTTING TOOL AND METHOD OF USE

(71) Applicant: Roger E. Robichaud, Bozeman, MT (US)

(72) Inventor: Roger E. Robichaud, Bozeman, MT (US)

(21) Appl. No.: 14/645,022

(22) Filed: Mar. 11, 2015

Related U.S. Application Data
(60) Provisional application No. 61/951,111, filed on Mar. 11, 2014.

(51) Int. Cl. G02B 6/38; B26D 1/18

(52) U.S. Cl. CPC G02B 6/3898; B26D 1/18

(57) ABSTRACT

A cutting tool comprising a housing, an adapter carried by the housing configured to receive and carry a connector or a ferrule, a slide, a saw assembly carried by the slide and comprising a motor bracket, a first motor attached to the motor bracket, and a saw blade operably connected to the first motor. The cutting tool also includes a second motor operably connected to the slide, a controller, and a power source. The first motor is operable to rotate the saw blade. The second motor is operable to translate the saw blade along a cutting path so as to interface with and cut at least one of a ferrule, a fiber, and an epoxy bead of the connector or the ferrule carried by the adapter. The saw blade may further comprise a coating comprising diamond crystals having an edge length within the range from 1 μm to 25 μm.

### FIELD OF THE INVENTION

The present invention relates to fiber optic epoxy cutting tool systems and methods for using a fiber optic epoxy cutting tool.

### BACKGROUND

Fiber optic cables are being installed worldwide to respond to the huge demand for high-speed communication technologies. Each installed cable can enclose hundreds of individual fibers, all of which must be connected. The construction, sometimes referred to as installation, of fiber optic connectors is usually accomplished in a factory environment but it is sometimes necessary to construct, or install, the connectors in the field under less than ideal circumstances.

Fiber optic connectors can be either a single fiber connector or a multiple fiber connector. Single fiber connectors enclose a precision cylindrical ferrule usually made of ceramic but can also be metal or polymer plastics. The bare fiber is threaded through the center axial hole of the ferrule and secured with epoxy. After curing, the protruding fiber and excess epoxy bead may be removed by polishing flush with the face of the ferrule. The polished ferrule face can be either perpendicular to the fiber axis (ninety degree ferrules) or at a slight angle, usually eight degrees from the perpendicular (angled ferrules). Processing the ferrule can be done either with the ferrule outside the connector body or pre-assembled within the connector body. In the case of multiple fiber connectors, a single connector can accommodate two or more fibers. This connector also has a ferrule that precisely positions all the fibers in a linear one-dimensional or two-dimensional array of two to forty-eight or more fibers. The fibers are threaded through the ferrule holes with epoxy and cured. The cured epoxy bead and protruding fibers may then be removed by polishing the epoxy and fiber flush with the face of the ferrule. Multiple fiber ferrules and connectors are also available with ninety degree and eight degree faces.

Presently, there are three main methods to remove the excess epoxy and fiber. The first method is used for high volume production in a factory environment. This method requires an initial investment in several expensive polishing machines, ongoing consumables expenses, such as polishing film and other supplies, and skilled labor to operate production lines. Many individual polishing steps are required to achieve an acceptable polished ferrule surface. This method is expensive and complex.

The second method uses a powerful industrial laser to vaporize most of the epoxy bead and fiber from the face of the ferrule. The remnant epoxy and fiber must then be polished flush with the face of the ferrule. This equipment is expensive, complex and bulky. As a result, use of the equipment is limited to high volume factory environments. Further complicating matters is the fact that the high energy of the focused laser beam can damage and melt the polymer material of some ferrule thus limiting its application. This is especially important for the MTP connector, a multiple fiber connector fabricated with a relatively low melting point thermoplastic. In addition, there are user safety concerns due to the toxicity of the vaporized material that is generated and high power of the laser beam.

The third, more conventional, method uses multiple manual polishing steps and relies on highly trained personnel. Polishing is tedious and labor intensive due to the many steps and the amount of time required in removing the epoxy bead and polishing the fiber flush with ferrule face.

What is needed is a new means for achieving a smooth surface at the face of the ferrule that is less complex, capable of deployment in the field, does not present health or safety concerns and which is faster and less expensive.

### SUMMARY OF THE INVENTION

The present invention advantageously fills the aforementioned deficiencies by providing a fiber optic epoxy cutting tool and method of use, which eliminates or dramatically reduces many conventional processing steps, including cleaving the protruding fiber(s), smoothing out the protruding fiber stub(s) (de-nubbing), and polishing off the epoxy bead and fiber(s) flush with the ferrule face. Furthermore, the costs of producing polished ferrule faces are dramatically reduced by expediting the process and thereby reducing labor costs, as well as eliminating or reducing the need for expensive equipment and consumables necessary for the process, such as polishing film.

The cutting tool of the present invention is an epoxy cutting tool used in the installation of fiber optic connectors either on the factory floor or in the field. A complete range of adapters are also available to process single and multiple fiber ferrules with either ninety degree or angled faces. Adapters are also available to process the ferrules when assembled in the connector body.

The cutting tool is designed to be adapted to cut through both the fiber and the hard epoxy that forms a bead at or around the exit hole(s) of the ferrule. By cutting close to the face of the ferrule, the device may advantageously remove a maximum amount of material, which greatly shortens processing. By reducing or eliminating processing steps, expenses associated with the installation of the fiber optic ferrules and connectors are greatly reduced.

Generally, components of the disclosed cutting tool may include a housing, an adapter, a saw blade, a first motor for the saw blade, a slide on which the saw blade and the first motor are mounted, a second motor that may be used to push the slide, electronics with a microprocessor, a battery, a power engage device and a first and second light source.

In one embodiment of the present invention, the cutting tool may include the saw blade, which may be made out of tungsten carbide, such as a cemented tungsten carbide for example and without limitation. More specifically, the material in this embodiment may be composed of tungsten carbide granule, which may be held together in a matrix of cobalt (WC—Co). While offering certain advantages, cobalt can create difficulties in terms of coating the blade with diamonds. Thus, the WC—Co material may preferably have a cobalt content equal to or less than 6% and that may be chemically removed from the surface prior to coating. Further, EDM machining may create a thin surface layer that may be full of byproducts of the EDM process, which may not be optimum for coating, and specifically diamond coating. It may be better to grind the surface of the saw blade to facilitate coating, e.g., diamond coating.

Certain grades of tungsten carbide that use nickel as a binder metal instead of cobalt may also be used for the saw blade. While not typically as commonly available, it may be useful in corrosive environments. The saw blade may also be made of many materials including and not limited to tungsten, tungsten alloy, single crystal silicon, sintered silicon carbide, single crystal silicon carbide and molybdenum, which may have their surfaces ground and coated with diamonds or other coatings.

Diamonds may be coated onto the surface of the tungsten carbide. When viewing the diamonds under a microscope a crystalline structure may be visible with sharp edges. Cutting may be accomplished by using the edge of the diamonds. The crystal edges may be extremely sharp and hard providing excellent cutting action.

When using the cutting tool according to embodiments of the present invention, the user may insert a ferrule or connector into the adapter and may engage power to initiate the cut cycle. The saw blade may cut across the epoxy bead and/or fiber and then retract the saw blade to await the next cut cycle. The result may be a cut that is very dose to the face of the ferrule, removing most of the epoxy bead and/or fiber.

The diameter of the glass fiber may generally be about 125 μm and the protrusion of the plurality of saw teeth is generally less than 4 μm. Therefore, under optimal conditions, the cut may occur at a range of between about 25 to about 75 microns away from the ferrule face. Of course, it is possible that the cut may occur at greater than 75 microns, but by keeping this distance as small as possible the polishing necessary may be kept to an absolute minimum. Cutting too close to the ferrule face, however, may create problems associated with fiber cracks propagating inside the ferrule, thus while it is possible to cut closer than 25 microns from the ferrule face, it may be advantageous to cut far enough away from the ferrule face to leave a certain amount of material remaining, which can be smoothed by a single polishing cycle, or at least a small number of polishing cycles. For example, cutting 50 μm away from the ferrule face may allow for minimization of the processing steps while still safely cutting and not risking propagation of cracks inside the ferrule. When cutting about 25 to about 75 microns away from the ferrule face a minimum number of polishing steps may remove the remaining epoxy and fiber and create a smooth ferrule face.

Among other reasons, the cutting tool, saw blade and methods of using the cutting tool according to embodiments of the present invention are unique when compared with other solutions specifically because: (1) the cutting tool may allow the user to quickly and accurately remove the bulk of the epoxy and fiber(s) in one quick step by cutting through the epoxy and fiber(s) simultaneously very close to the ferrule face; (2) the cutting tool may be small, lightweight, may be battery powered and easily portable; (3) the cutting tool may provide flat, calibrated and reproducible cuts a fixed distance from the face of the ferrule; (4) the cutting tool may be used with all ferrule or connector materials, including metals, ceramics and low melting temperature thermoplastics; and (5) the cutting tool (in at least some embodiments) may have an extremely long service lifecycle due to the resiliency of the cutting materials, i.e., diamonds, employed on the surface of the saw blade.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein. Rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a right perspective view of a portion of the cutting tool according to an embodiment of the present invention.

FIG. 2 is a left perspective view of a portion of the cutting tool illustrated in FIG. 1.

FIG. 3 is an overhead perspective view of a portion of the cutting tool illustrated in FIG. 1, and including a housing.

FIG. 4 is a magnified overhead perspective view of a portion of the cutting tool illustrated in FIG. 3.

FIG. 5 is a side perspective view of a saw assembly of the cutting tool illustrated in FIG. 1.

FIG. 6 is a perspective view of a cutting tool according to an embodiment of the present invention.

FIG. 7 is another perspective view of the cutting tool illustrated in FIG. 6 and showing a housing cover.

FIG. 8 is a perspective view of a saw blade of a cutting tool according to an embodiment of the present invention.

FIG. 9 is a side elevation view of the saw blade illustrated in FIG. 8.

FIG. 10 is a front elevation view showing an edge of the saw blade illustrated in FIG. 8.

FIG. 11 is another perspective view of the saw blade illustrated in FIG. 8.

FIG. 12 is a magnified photograph of a front elevation view of an edge of a saw blade of a cutting tool according to an embodiment of the present invention.

FIG. 13 is a magnified photograph of a side perspective view of an edge of a saw blade of a cutting tool according to an embodiment of the present invention.

FIG. 14 is an even greater magnified photograph of the saw blade depicted in FIG. 13.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a saw blade, a fiber optic epoxy cutting tool, and method of use of a fiber optic epoxy cutting tool.

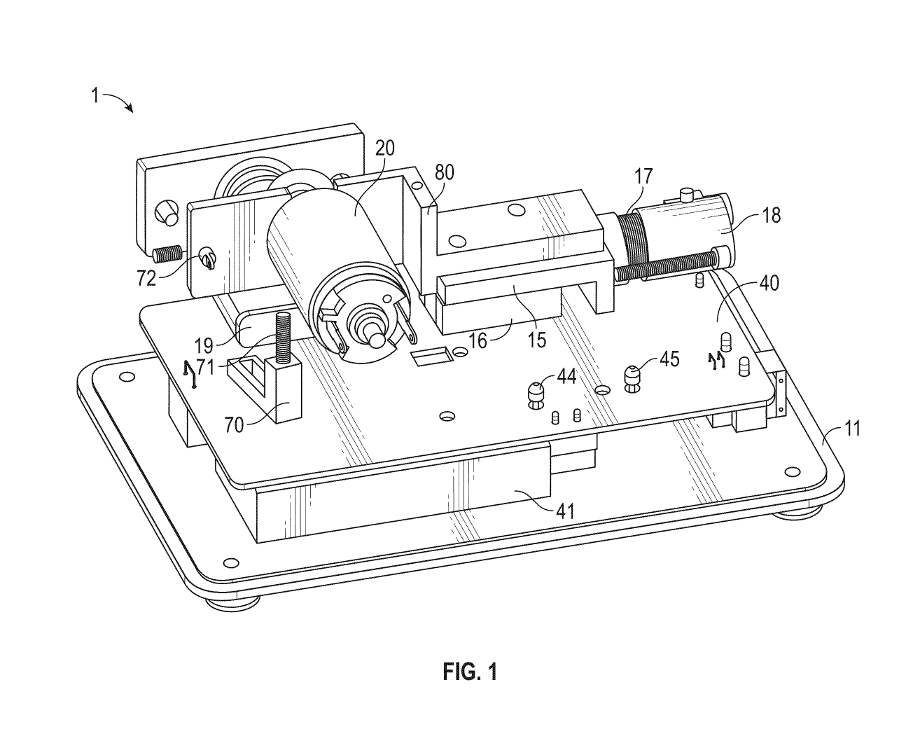

Referring to FIGS. 1-7 generally, a cutting tool 1 according to an embodiment of the present invention may be an epoxy and/or fiber cutting tool, which may be utilized during the installation of fiber optic ferrules or connectors. The cutting tool 1 according to an embodiment of the present invention may include a housing 10 which may protect and securely mount all components relative to each other. The cutting tool 1 may also include a housing base 11, a housing cover 12, an adapter 52, and a saw assembly 22 (as shown in FIG. 5) which may include a saw blade 30. The adapter 52 may be carried by a vertical wall of the housing 10 whereby a user may insert a connector 50 or a ferrule 62 which may be in need of cutting. The saw blade 30 may be a diamond coated saw blade and may have a substantially circular shape. The saw assembly 22 may also include a first motor 20. When operated, the first motor 20 may drive a motor shaft that the saw blade 30 is connected to so that rotation of the motor shaft causes rotation of the saw blade 30. More particularly, a hub 14 may be provided to couple the saw blade 30 to the motor shaft. The saw assembly 22 may be mounted on a slide 16 so that the saw blade 30 can be moved across an epoxy bead 60 and a fiber 61.

Referring now more specifically to FIGS. 1-3, the cutting tool 1 may further include a bracket 15 and a second motor 21 that may push the slide 16 in a latitudinal direction. More particularly, the second motor 21 may push the slide 16 so that the saw blade 30 is directed toward the connector 50, the ferrule 62, the epoxy bead 60, and/or the fiber 61 in need of cutting.

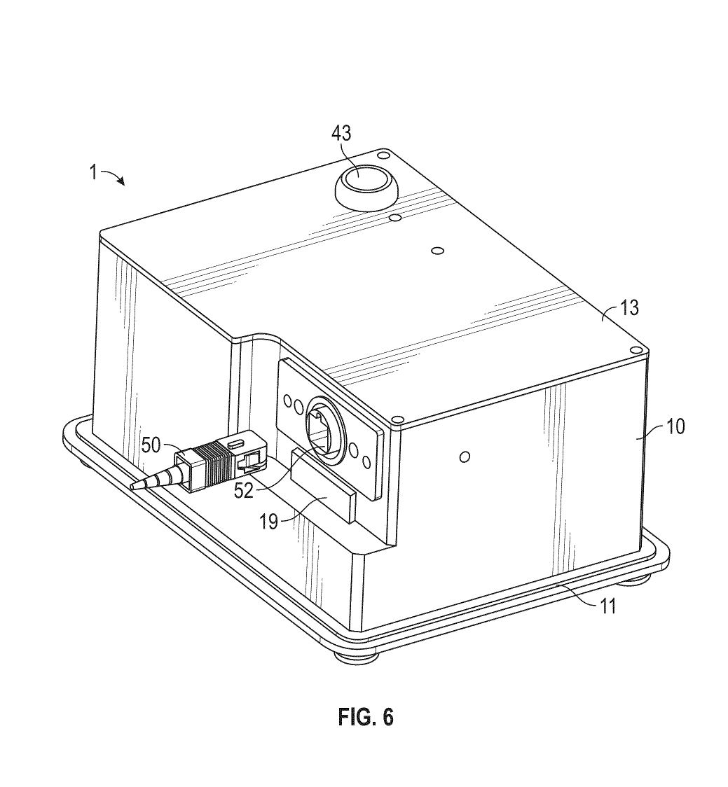

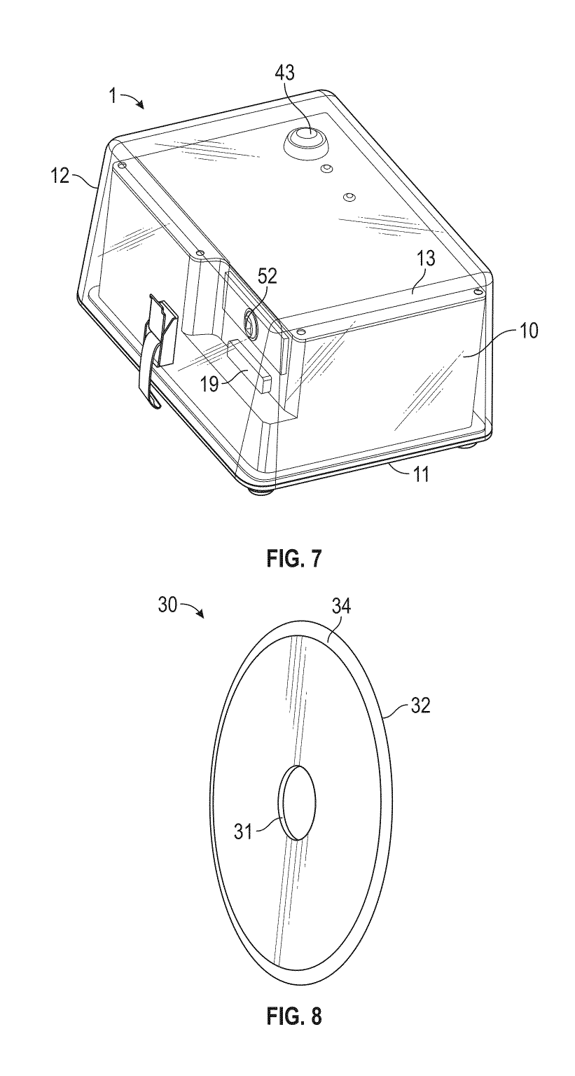

The cutting tool 1 may further include a power engage device 43 (as shown FIGS. 6-7) which may initiate a cut cycle, a power input jack 42, a controller, a battery 41 which may be used for energy storage and field use, and a first and second light source 44, 45. The controller may be provided by a printed circuit board 40 (PCB) which may include electronic components and a microprocessor which may be provided to control all aspects of the cutting tool 1 including the cut cycle and battery function. The first and second light source 44, 45 may be used to indicate desired information. For example and without limitation, the first light source 44 may provide an indication of the battery 41 status and the second light source 45 may provide an indication of the cut cycle.

The cutting tool 1 may further include the adapter 52 which may allow the cutting tool 1 to accommodate any connector 50 and ferrule 62. Furthermore, the adapter 52 may accommodate any commercially available single fiber or multifiber ferrule and/or connector without limitation. The cutting tool 1 may first cut the epoxy bead 60 and/or the fiber 61 then the cutting tool 1, or another device may be used to polish the remaining epoxy bead 60 and/or the fiber 61 so that the epoxy bead 60 and the fiber 61 may be flush or nearly flush with the face of the ferrule 62. Those skilled in the art will appreciate that the epoxy bead 60 and the fiber 61, or the remnants thereof, may be manually polished flush or nearly flush with the face of the ferrule 62, if so desired, by the user. The epoxy bead 60 and/or the fiber 61 may be assembled in the ferrule 62, as part of the ferrule 62, and/or along with the ferrule 62 before processing. The ferrule 62 can be processed by itself or assembled in the connector 50 before processing.

Those skilled in the art will appreciate that the adapter 52 may include ferrule adapters, connector adapters, or other types of adapters 52 as desired. For example and without limitation, the adapter 52 may be available for a 2.5 mm diameter, single fiber ferrule used in SC, FC, ST, SMA, SC/APC and FC/APC connectors. As another example and without limitation, the adapter 52 may be available for the 1.25 mm diameter, single fiber ferrule used in LC, MU, LC/APC and MU/APC connectors. As yet another example, and without limitation, the adapter 52 may be available for a MT and a MT pre-angled ferrule used in a MTP multifiber connector. The previous illustrations exemplify the flexibility of the adapter 52 design and in no way are meant to limit it to the specific connectors mentioned.

Referring to FIGS. 3-4 and 6-7, the adapter 52 may be mounted on one of the vertical walls of the housing 10 and may serve as the interface between a specific type of connector 50 or ferrule 62 and the saw blade 30. The adapter 52 may be designed to accommodate all currently available types of connector 50 and ferrule 62. For example and without limitation, the adapter 52 may be an SC Connector Adapter. The function of the adapter 52 may be to allow the user to securely position the face of the ferrule 62 a predetermined distance from the cutting path of the saw blade 30. The adapter 52 may also be adjustable so that the distance away from the cutting path of the saw blade 30 may be increased or decreased as preferred. As an example and without limitation, the epoxy bead 60 and the fiber 61 layer thicknesses left adhering on the face of the ferrule 62 after cutting may be adjusted to 50 μm by adjusting the adapter 52 to increase or decrease the distance between the cutting path of the saw blade 30 and the face of the ferrule 62. The distance may also be adjusted by using a different adapter or another adapter in addition to the adapter 52.

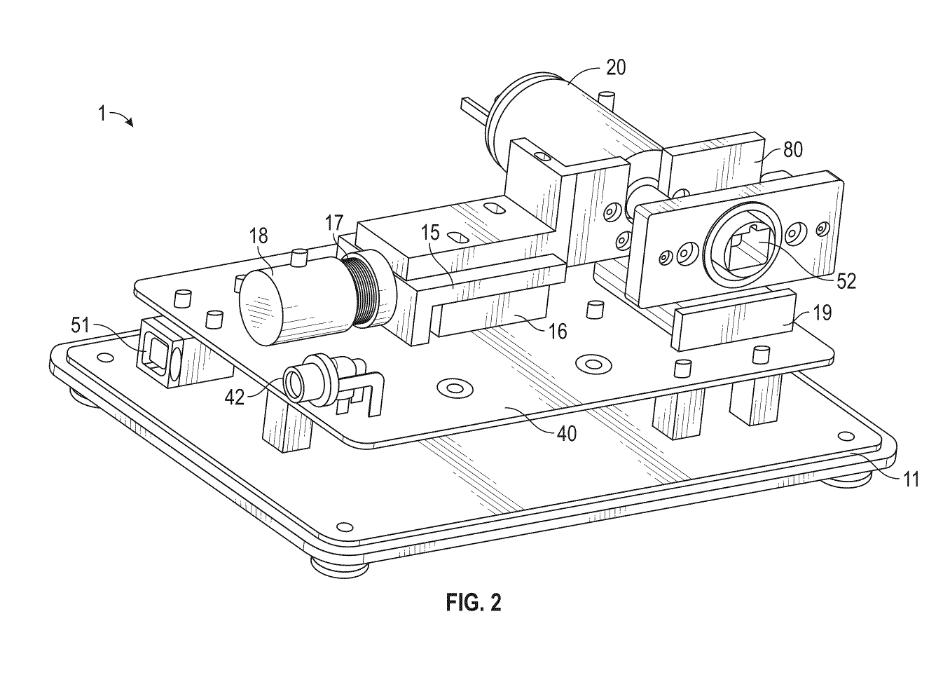

Referring to FIG. 2, the cutting tool 1 may further include a USB port 51 which may provide external communication with the microprocessor of the cutting tool 1. The USB port 51 may be used to initially load operating software into the microprocessor, which may define the operation of the cutting tool 1. The USB port 51 may also be used to update operating software for the cutting tool 1, for troubleshooting, and/or for uploading operating data for analysis. The USB port 51 may also serve to facilitate communication between the PCB 40, the microprocessor, and/or an onboard computer and a computing device, such as a computer, a desktop computer, a laptop computer, a tablet, or a phone. More specifically, and without limitation, the USB port 51 may facilitate communication with the PCB 40 and/or the microprocessor.

For example and without limitation, the USB port 51 may be used to communicate with the epoxy cutting tool 1 by connecting it to a computing device, such as a computer, a desktop computer, a laptop computer, a tablet, or a phone. Operating variables, operating definitions, operating historical data, or other information may be accessed, displayed, inputted, or extracted by the computing device. For example and without limitation, such variables may include motor rotations per minute, motor velocity (forward velocity of saw assembly 22 or saw blade 30), battery charging rate, battery low voltage level, etc. Changes to the operating variables, operating definitions, operating historical data, or other information may be made by the computing device if desired by a user. This may be done, for instance, for the first time after mechanical assembly of the epoxy cutting tool 1 in order to set the operating variables. The operating variables may define how the epoxy cutting tool 1 will operate. After use, historical data may be extracted, for instance, from the epoxy cutting tool 1. The historical data may include, for instance, the number of cuts taken or other data for keeping track of the lifetime of the saw assembly 22 or the accuracy of the saw blade 30.

Referring to FIGS. 1-4 and 6-7, the housing 10 and/or the housing base 11 may serve as a base to protect and mount any or all components relative to each other. The housing 10 may rest on the housing base 11 or may be attached to the housing base 11 through the use of an adhesive, glue, latch, screw, bolt, nail, or any other attachment method as may be understood by those skilled in the art after having had the benefit of this disclosure. Similarly, and referring now more specifically to FIG. 7, the housing cover 12 may be attached to the housing 10 and/or the housing base 11 or may rest on the housing 10 and/or the housing base 11 through the use of an adhesive, glue, latch, screw, bolt, nail, or any other attachment method as may be understood by those skilled in the art after having had the benefit of this disclosure. The housing cover 12 may, for example, be a protective transparent cover, but the skilled artisan will appreciate that the present invention contemplates the use of an opaque material, a translucent material, and/or a solid material for the housing cover 12 as well.

As illustrated, for example, in FIGS. 6-7, in some embodiments, the housing 10 may include a cover portion 13. Those skilled in the art will appreciate that the cover portion 13 may be included as a portion of the housing 10, but may also be an additional member that is connected to an upper portion of the housing 10, e.g., an overlying portion that is adapted to be connected to the upper portion of the housing 10.

Referring to FIGS. 6-7, the power engage device 43 is shown as a button. Those skilled in the art, however, will appreciate that the power engage device 43 may include a button, a switch or similar mechanism. The first and second light sources 44, 45 may be mounted on the cover portion 13 of the housing 10 and readily accessible to a user.

Referring to FIG. 5, the saw blade 30 may be mounted on the hub 14 which may, in turn, be mounted on the motor shaft. The saw assembly 22 may include the saw blade 30, a motor bracket 80, the hub 14 and the first motor 20. The first motor 20 may be detachably attached to the motor bracket 80 through the use of an adhesive, glue, latch, screw, bolt, nail, or any other attachment that as may be understood by those skilled in the art after having had the benefit of this disclosure.

Referring to FIGS. 1-4, the saw assembly 22 may be mounted and/or resting on the bracket 15 which may rest on the slide 16 and may be pushed in a latitudinal direction along the slide 16 by the second motor 21 towards the epoxy bead 60 and/or the fiber 61, which may bring the saw blade 30 in contact with the epoxy bead 60 and/or the fiber 61 and may cut the epoxy bead 60 and/or the fiber 61. The fiber 61 may be partially or completely embedded within the epoxy bead 60.

Referring to FIGS. 3-6, a method of using the cutting tool 1 may include inserting the connector 50 in the adapter 52 and activating power to initiate the cut cycle. By activating the power engage device 43, the first motor 20 and/or the second motor 21 may operate at least one time. The power engage device 43 may engage the battery 41 which may activate the first and/or second motor 20, 21. The power engage device 43 or the battery 41 may electronically communicate with the PCB 40 and/or the microprocessor to activate the first motor 20 and/or the second motor 21. The method of using the cutting tool 1 may further include connecting the power input jack 42 to a power source, such as an external power source or wall outlet.

Additionally, the first motor 20 may activate the saw blade 30 thereby causing the saw blade 30 to rotate. More specifically, the first motor 20 may engage the hub 14 and/or the motor shaft thereby causing the hub 14 and/or the motor shaft to rotate. The rotation of the hub 14 and/or the motor shaft may cause the saw blade 30 to rotate.

In one embodiment of the present invention, insertion of the connector 50 into the adapter 50 may cause the cutting tool 1 to activate as if the power engage device 43 was engaged.

Those skilled in the art will appreciate that the saw assembly 22 may further include the second motor 21 or a portion of the second motor 21. Those skilled in the art will also appreciate that the second motor 21 may be attached to the housing 10 through the use of an adhesive, glue, latch, screw, bolt, nail, or any other attachment that as may be understood by those skilled in the art after having had the benefit of this disclosure.

The saw blade 30, the first motor 20, the hub 14, the bracket 15 and/or the saw assembly 22 may slide or move in a latitudinal direction along the slide 16 when the second motor 21 is activated. The second motor 21 may cause the saw blade 30, the first motor 20, the hub 14, and/or the saw assembly 22 to slide the saw blade 30 into position to engage and cut or trim the epoxy bead 60 and/or the fiber 61 at least one time thereby completing a cut cycle. Those skilled in the art will appreciate that any number of cut cycles may be used to cut or trim the epoxy bead 60 and/or fiber 61 as desired by a user or as determined by software, the PCB 40, the microprocessor, and/or through external input such as through a computer or computing device communicating with and/or through the USB port 51.

The first motor 20, the second motor 21, the PCB 40, the battery 41, the power input jack 42, the power engage device 43, the first light source 44, the second light source 45, and the USB port 51 may electronically communicate with each other. The PCB 40 may include the microprocessor which may be an onboard microprocessor and may control all aspects of the cut cycle, cutting tool 1 and/or operation of the cutting tool 1. For example and without limitation, the PCB 40 and/or microprocessor may control power to the first motor 20 and/or the second motor 21 individually or jointly through Pulse Width Modulation (PWM). The PCB 40 and/or microprocessor may further control the battery 41 and/or the status indication and charging of the battery 41. Software and/or programs may be loaded into the microprocessor and/or PCB 40 to define all aspects or some aspect of the cut cycle, cutting tool 1 and/or operation of the cutting tool 1. The cutting tool 1, through the PCB 40 and/or microprocessor for example and without limitation, may accumulate performance data, extract performance data as needed for troubleshooting and/or analyze performance data for cutting performance. Operating data may be accumulated and inspected with a computer or other electronic device. For example and without limitation, using a counter, the number of accumulated cut cycles may be inspected.

The first and second motor 20, 21 may be provided by an AC motor, a DC motor, an electrostatic motor, a servo motor, a stepper motor, an actuator, a hydraulic motor, a pneumatic motor, a voice coil motor, an electromagnet, and/or a permanent magnet. Those skilled in the art will appreciate that any device suitable to cause rotation and/or sliding may be used as the first and second motor 20, 21, without limitation. The first and second motor 20, 21 may be provided by the same or different devices and may also include any other device that may impart a rotational, pivotal, sliding, or other similar action on the saw blade 30 and/or saw assembly 22. For example and without limitation, the first motor 20 may be an AC motor. The second motor 21 may be a voice coil motor. More specifically in referring to FIGS. 1-3, the second motor 21 may include a coil 17 and a cylindrical magnet 18.

Referring to FIG. 1, a right view of the cutting tool 1 is depicted with the housing 10 removed. On top of the PCB 40, close to the near edge, the first and second light source 44, 45 may be visible. For example and without limitation, the second light source 45 may provide information on the cut cycle while the first light source 44 may indicate the status of the battery 41. The light from the first and second light source 44, 45 may be transmitted through the housing cover 12 and/or the cover portion 13 of the housing 10 with plastic light pipes or other light conveying devices and thus be visible to the operator. The battery 41 may be positioned to underlie the PCB 40. Further, the battery 41 may be rechargeable and may provide portability when away from a power source.

The first and second light sources 44, 45 may include any device capable of emitting light. The first and second light sources 44, 45 may, for example and without limitation, include incandescent lights, halogens, fluorescents (including compact-fluorescents), high-intensity discharges, light emitting semiconductors, such as light-emitting diodes (LEDs), lasers, and any other light-emitting device that as may be understood by those skilled in the art after having had the benefit of this disclosure. Those skilled in the art will appreciate that any number of light sources may be used to indicate other functions, such as the status of the battery 41, for example and without limitation, whether the battery 41 is fully charged, partially charged, in the process of charging, or void or nearly void of any charge. For example and without limitation, the first and second light source 44, 45 and/or any number of light sources may also indicate whether the device is currently operating or finished operating. Those skilled in the art will further appreciate that any number of color combinations may be used to display different information as desired. Those skilled in the art will also appreciate that no light source is necessary for the operation of the cutting tool 1 and none is required for the present invention.

FIG. 2 illustrates a left view of the cutting tool 1 with the housing 10 removed, thus displaying internal components of the cutting tool 1. The cutting tool 1 may include the PCB 40, the first and second motors 20, 21, the adapter 52, and a waste bin 19 underneath the adapter 52. Those skilled in the art will appreciate that the waste bin 19 may be positioned underneath the adapter 52 to advantageously capture as much waste as possible that falls due to gravity, but the waste bin 19 may be positioned anywhere while still accomplishing the goals, features and objectives according to the present invention. The waste bin 19 may collect debris generated by the saw blade 30. Also illustrated is the coil 17 of the second motor 21, which may be partly covered by the cylindrical magnet 18. The coil 17 may slide freely within the cylindrical magnet 18. The coil 17 and/or the cylindrical magnet 18 may be mounted on the housing 10, the housing base 11, the motor bracket 80 and/or the slide 16. The second motor 21 may generate a force necessary to push at least one of the saw blade 30 and the saw blade assembly 22 and stretch an extension spring (not shown in FIG. 1) providing a return force for the saw blade 30 and/or the saw assembly 22. The return extension spring may be mounted between a spring anchor 71 which may be mounted on top of a spring adjust slide 70 and a spring anchor 72 mounted on the end of the motor bracket 80. Spring return tension may be adjusted by sliding the spring adjust slide 70, thus increasing or decreasing spring tension and the return force. The first motor 20, including the saw blade 30, the hub 14, the motor shaft, and/or the saw assembly 22, may be mounted, attached, and/or rest on the bracket 15. Alternatively, the first motor 20, including the saw blade 30, the hub 14, the motor shaft, and/or the saw assembly 22, may rest on a different bracket (not shown) and/or may be mounted or attached to the different bracket through the use of an adhesive, glue, latch, screw, bolt, nail, or any other attachment that as may be understood by those skilled in the art after having had the benefit of this disclosure. The different bracket may further be attached to the bracket 15 through the use of an adhesive, glue, latch, screw, bolt, nail, or any other attachment that as may be understood by those skilled in the art after having had the benefit of this disclosure.

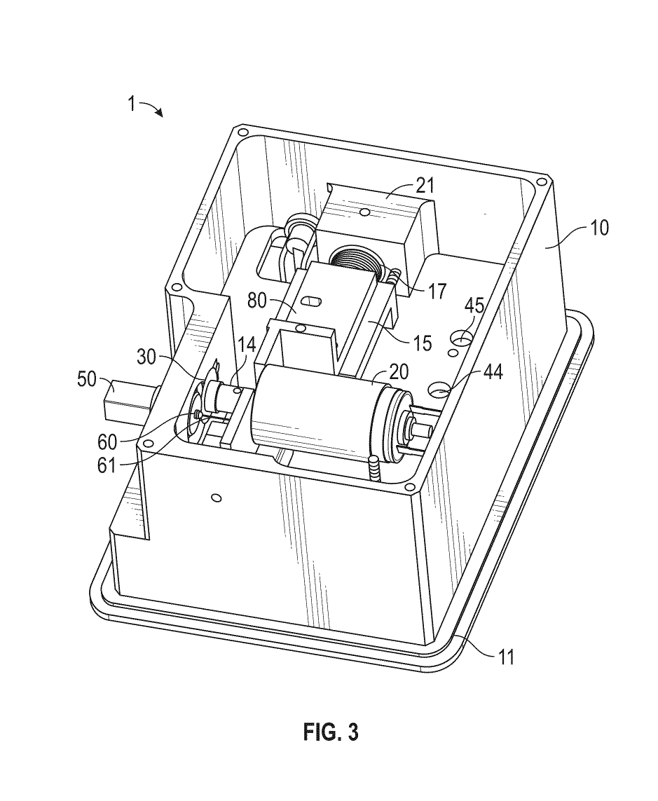

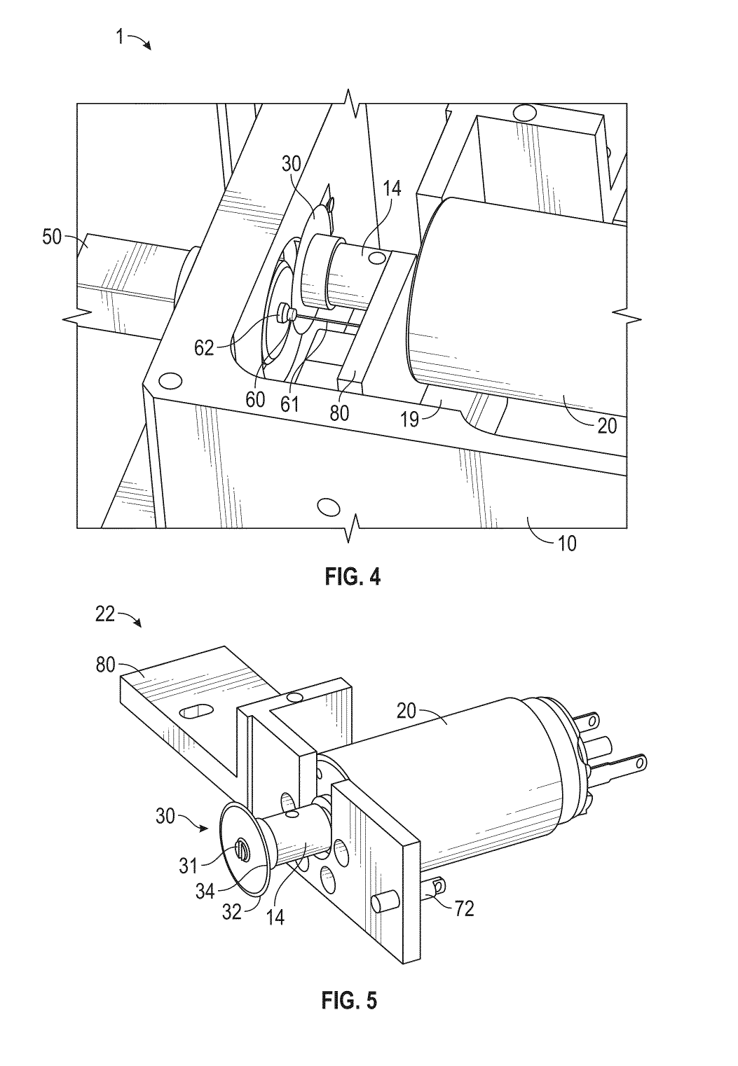

Referring to FIG. 3, the cutting tool 1 is shown with the housing cover 12 and a portion of the housing 10 removed. As illustrated in FIG. 3, the saw blade 30 may cut into the epoxy bead 60 and/or the fiber 61 close to the surface of the ferrule 62. FIG. 4 is a close-up view of FIG. 3 and shows the saw blade 30 cutting the epoxy bead 60 and fiber 61 close to the surface of the ferrule 62.

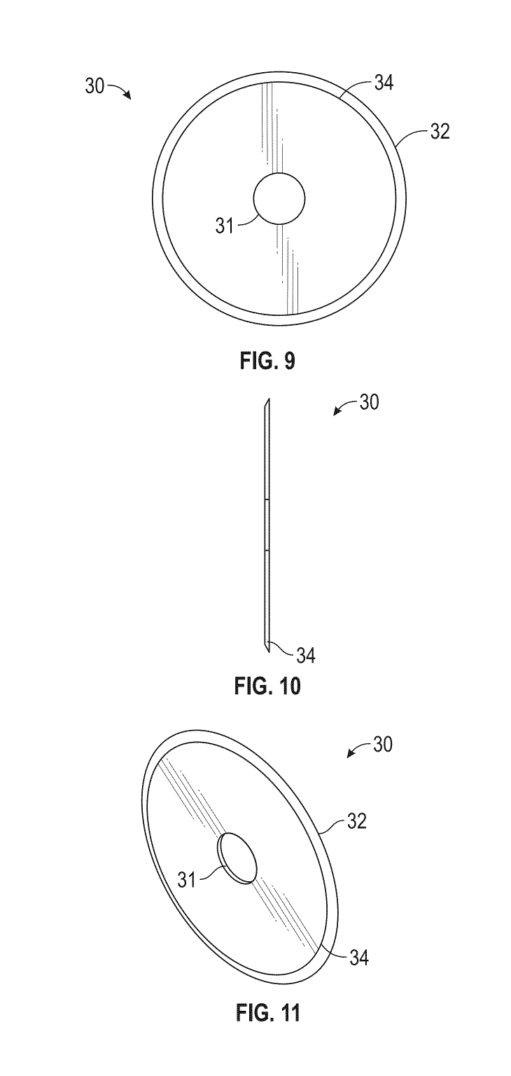

Referring generally to FIGS. 8-14, the saw blade 30 has been described in terms of specific embodiments. When referring to FIGS. 1-7, the cutting tool 1 is described in terms of specific embodiments which may include the saw blade 30. The saw blade 30 may include an inner passageway 31, a plurality of saw teeth 32, and/or a coating 34. The inner passageway 31 may be machined so that it has a close slip fit on the hub 14 and/or motor shaft. The inner passageway 31 may be any diameter as desired by the user so that it may fit on the hub 14 and/or motor shaft. The plurality of saw teeth 32 may include edge lengths 33 which may determine the fineness of the cutting performed by the saw blade 30. The diameter of the saw blade 30 may be adjusted as desired by a user and therefore the saw blade 30 may be a circular saw blade of any size. The plurality of saw teeth 32 may be sharp and hard, which may provide superior cutting. The plurality of saw teeth 32 may enable cutting through the epoxy bead 60 and/or the fiber 61 close to the surface of the ferrule 62 without propagated fracturing of the fiber 61 inside the ferrule 62. For example and without limitation, the fiber 61 may include a glass fiber. Those skilled in the art will appreciate that the saw blade 30 may be any type of blade that as may be understood by those skilled in the art after having had the benefit of this disclosure or may be the blade for any type of saw assembly that as may be understood by those skilled in the art after having had the benefit of this disclosure. For example and without limitation, the saw blade 30 may be or may be a part of an abrasive saw, a reciprocal saw, a band saw, a wire saw, a biscuit joiner, a brushcutter, a carbide saw, a cold saw, a concrete saw, a flip over saw, a miniature circular saw, a miter saw, a chop saw, a cut-off saw, a multi-tool, a panel saw, a pendulum saw, a swing saw, a radial arm saw, a sally saw, and/or a table saw.

For example, and without limitation, the saw blade 30 may be machined out of tungsten carbide material, more specifically, cemented tungsten carbide material, with 0.8 μm to 1.4 μm grain size and 0% to 10% cobalt. As another example, and without limitation, the saw blade 30 may be machined out of cemented tungsten carbide material with 1.2 μm to 1.4 μm grain size and 0% to 6% cobalt. As yet another example, and without limitation, the saw blade 30 may be machined out of cemented tungsten carbide material with about 1.2 μm grain size and about 6% cobalt. Any range within these ranges would be acceptable and the ranges provided are only exemplary. Those skilled in the art will appreciate that yet additional and larger, smaller, or different ranges may be acceptable.

The coating 34 of the saw blade 30 may comprise crystals and may use the crystal edges of the crystals as the plurality of saw teeth 32. The crystals may be diamond crystals. The crystals may be grown directly on the saw blade 30 using a Chemical Vapor Deposition (CVD) process. This process strongly anchors the crystals to the body of the saw blade 30, contributing to its extended lifetime. Crystal size is important in determining aggressiveness of the cutting action of the saw blade 30. The crystals must be sufficiently small to minimize cutting damage to the fiber 61 to allow for subsequent successful polishing but also relatively large to minimize cutting time. Crystals with maximum edge length 33 of about 10 μm to about 12 μm may be preferred, but crystal edge length 33 may range from about 1 μm to about 25 μm depending on the volume of epoxy that is desired to be cut. For example and without limitation, a more aggressive saw with larger teeth may be more advantageous for cutting a larger epoxy volume. Those skilled in the art will appreciate that the coating 34 may comprise other types of crystals, metals or any other material or combination of materials that as may be understood by those skilled in the art after having had the benefit of this disclosure.

In one embodiment, for example and without limitation, the saw blade 30 material must both survive the high temperature of the CVD process and be suitable for diamond crystal growth. One suitable material may be tungsten carbide, such as cemented tungsten carbide, with a 1.2 μm grain size and a 6% cobalt content.

The extreme hardness of the diamond crystals relative to epoxy and glass may assure the saw blade 30 a long cutting lifetime. Heat generated at the plurality of saw teeth 32 may be efficiently carried away to a tungsten carbide base material due to the extremely high heat conductivity of diamond. This may be desirable because any excessive heat generation, such as due to cutting and/or friction, may not only soften or melt the epoxy, compromising cutting efficiency, but also contribute to the wear of the diamond cutting edges, also compromising the cutting efficiency of the saw blade 30.

Referring to FIGS. 8-11, the saw blade 30 may include a finished tungsten carbide (WC—Co), such as a cemented tungsten carbide, saw when machining is completed. The perimeter of the saw blade 30 may have the best concentricity possible with the motor shaft. All surfaces or some of the surfaces of the saw blade 30 may include the coating 34.

For example and without limitation, the plurality of saw teeth 32 may be only about 0.4 μm to about 10 μm deep. Corresponding diamond edge lengths may be about 1 μm to about 25 μm. As another example and without limitation, the plurality of saw teeth 32 may preferably be only about 4 μm deep. Those skilled in the art will appreciate that larger saw teeth 32 may be preferred if there is more epoxy to be removed and smaller saw teeth 32 may be preferred if there is less epoxy to be removed. Those skilled in the art will also appreciate that when the amount of epoxy is increased, the edge length 33 may also be increased. The increase in the edge length 33 may make the cutting tool 1, the saw assembly 22, and/or the saw blade 30 more effective and may minimize the time required to make a cut. Those skilled in the art will further appreciate that if the ferrule 62 is smaller or the epoxy amount is lessened, the edge length 33 may be decreased. As a result, the cut may be smoother and fiber cracking may be reduced or minimized, thus allowing a cut closer to the face of the ferrule 62. The amount of epoxy may determine the size of the saw assembly 22, the saw blade 30, the saw teeth 32, and/or the edge length 33 and multiple saw designs may be desired. For example and without limitation, the amount of epoxy desired to be removed for the single fiber ferrule may be less than the amount of epoxy desired to be removed with the MT (multiple fiber) ferrule. Thus, for example and without limitation, the size of the saw assembly 22, the saw blade 30, the saw teeth 32, and/or the edge length 33 may be different for the single fiber ferrule compared to the MT ferrule.

The perimeter of the saw blade 30 may have about a 10° to about a 45° chisel edge which may increase the cutting pressure. This perimeter may also have a chisel point angle about 90°, having no chisel point or nearly no chisel point, to about 10°. For example and without limitation, the saw blade 30 may also be reversed when mounted on a mandrel with a chisel point away from the face of the ferrule 62. Those skilled in the art will appreciate that the chisel point may be preferably close to the face of the ferrule 62.

Wire Electrical Discharge Machining (WEDM), Sinker Electrical Discharge Machining (Sinker EDM) and precision grinding may be used to produce the saw blade 30. The tungsten carbide, such as cemented tungsten carbide for example and without limitation, may include about 6% cobalt as a binder and tungsten carbide particles may be about 1.2 μm grain size. The coating 34 of the saw blade 30 may be crystals, diamond, and/or diamond crystals.

Referring to FIGS. 8-14, in some embodiments of the present invention, the diamonds may be coated on a saw blade 30 that may include tungsten carbine, such as cemented tungsten carbide for example and without limitation. For example and without limitation, the diamonds may be coated on a saw blade 30 that may be Ultra Carbide Inc., DK 120, 6% Co, 1.2 μm grain size. In some embodiments, the coating 34 thickness may be about 23 μm. The coating 34 thickness may be determined by the crystal, diamond and/or diamond crystal size. As the coating 34 thickness increases, the surface roughness may increase (or edge length 33 may increase). For smaller edge lengths 33, the thickness of the edge length 33 may be thinner. For example, an edge length 33 of 10 μm may require a thickness of about 23 μm. Diamond crystal edge length 33 of about 3 μm to about 12 μm may be preferred, although about 1 μm to about 25 μm may be effective depending on the amount of epoxy that needs to be removed. For a smoother cut surface, a smaller edge length 33, such as about 1 μm, may be used, with, for example and without limitation, a diamond layer thickness of as little as about 4 μm which may be preferred.

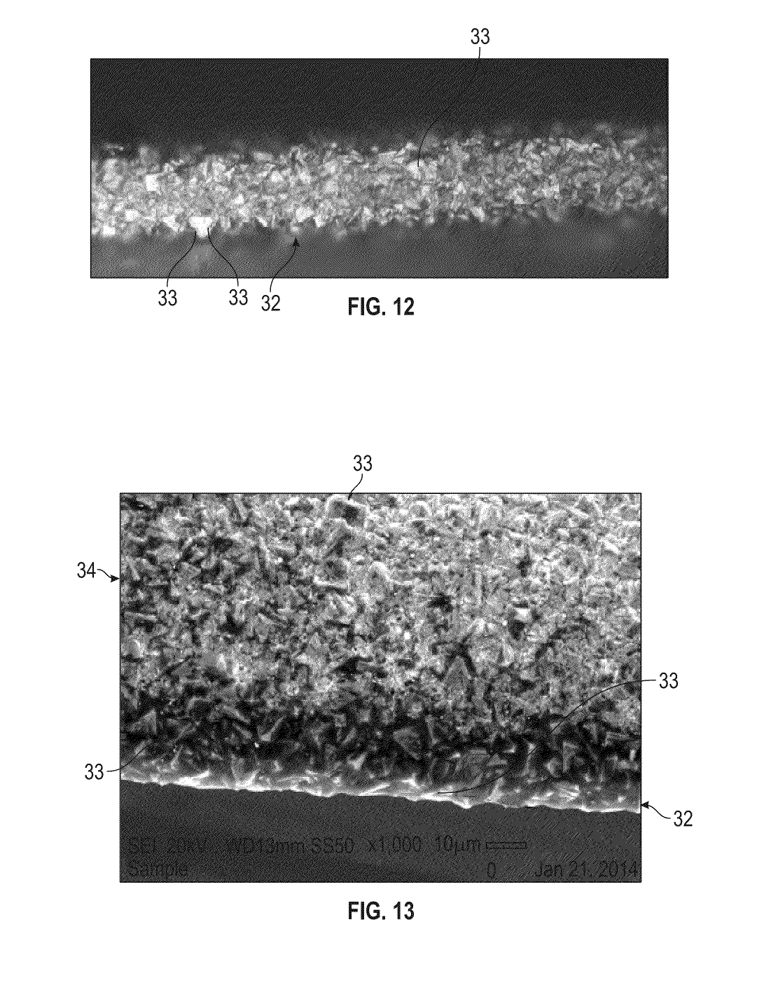

Referring to FIG. 12, a microscope photo of the diamonds on the perimeter of the saw blade 30 is illustrated. The width of the saw blade 30 at the perimeter shown in FIG. 12 may be about 33 μm and the longest edge length 33 may be about 10 μm.

Referring now to FIG. 13, a scanning electron microscope (SEM) image of the saw blade 30 looking parallel to the direction of the motor shaft at the perimeter of the saw blade 30 is illustrated. The crystals, with their sharp edges, may be ready to cut into the epoxy bead 60 and/or fiber 61.

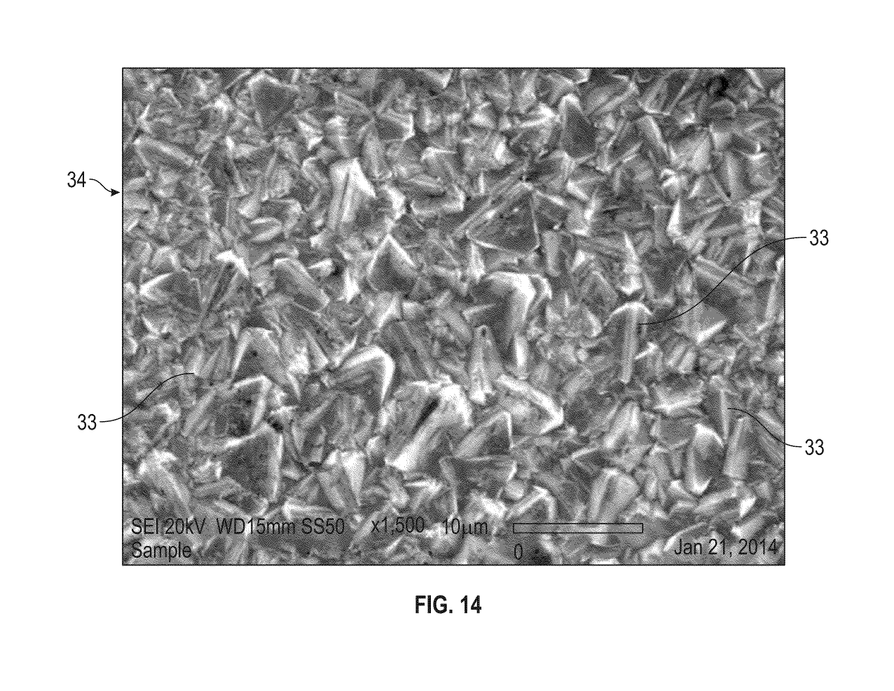

FIG. 14 is a close up of a diamond field illustrating a maximum edge length 33 of about 10 μm. FIG. 14 illustrates one of the flat face sidewalls of the saw blade 30.

Although the examples provided herein refer primarily to a fiber optic cutting tool, those skilled in the art will appreciate that the cutting tool 1 may be used in a variety of different applications and may be used to cut a variety of different materials and objects. The adapter 52 may be designed to accommodate these different materials and objects and the connector 50 may include these different materials and objects.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A cutting tool comprising:
a housing;
an adapter carried by the housing configured to receive and carry at least one of a connector and a ferrule;
a slide;
a saw assembly carried by the slide and comprising:
a motor bracket,
a first motor attached to the motor bracket, and
a saw blade operably connected to the first motor;
a second motor operably connected to the slide;
a controller connected to and configured to control the operation of each of the first motor and the second motor; and
a power source electrically connected to each of the first motor, the second motor, and the controller;
wherein the first motor is operable to rotate the saw blade;
wherein the second motor is operable to translate the saw blade along a cutting path so as to interface with and cut at least one of a ferrule, a fiber, and an epoxy bead of the connector or the ferrule carried by the adapter; and
wherein the saw blade is formed of a material selected from the group consisting of tungsten, tungsten carbide, tungsten carbide including a nickel binder, tungsten carbide including a cobalt binder, tungsten alloy, single crystal silicon, sintered silicon carbide, silicon carbide, single crystal silicon carbide, and molybdenum.

2. The cutting tool of claim 1 further comprising a data port in communication with the controller;
wherein the data port is configured to establish communication between the controller and a computing device;
wherein the controller is configured to receive data from and transmit data to the computing device via the data port; and
wherein the data comprises at least one of operating variables, operating definitions, and operating historical data.

3. The cutting tool of claim 2 wherein the controller is configured to change operating variables of the cutting tool responsive to data received from the computing device.

4. The cutting tool of claim 1 wherein the saw assembly further comprises a hub coupled to each of the first motor and the saw blade.

5. The cutting tool of claim 1 further comprising a return extension spring attached to the saw assembly and the housing and configured to exert a return force on the saw assembly when the second motor translates the saw blade.

6. The cutting tool of claim 5 further comprising a spring adjust slide; wherein the return extension spring is attached to the spring adjust slide; and wherein a magnitude of the return force exerted by the return extension spring is adjustable by adjusting the spring adjust slide.

7. The cutting tool of claim 1 wherein the tungsten carbide material is a cemented tungsten carbide material having a grain size within the range from 0.8 μm to 1.4 μm and including a cobalt composition within the range from 0% to 10%.

8. The cutting tool of claim 1 wherein the tungsten carbide material is a cemented tungsten carbide material having a grain size within the range from 1.2 μm to 1.4 μm and including a cobalt composition within the range from 0% to 6%.

9. The cutting tool of claim 1 wherein the tungsten carbide material is a cemented tungsten carbide material having a grain size of 1.2 μm and including a cobalt composition of 6%.

10. The cutting tool of claim 1 wherein the power source is at least one of a battery, a rechargeable battery, an AC power source and a DC power source.

11. The cutting tool of claim 1 further comprising an LED electrically connected to and operable by the controller.

12. The cutting tool of claim 11 wherein the controller is configured to operate the LED to emit light responsive to at least one of a status of the power source and a cutting cycle of the cutting tool.

13. The cutting tool of claim 1 wherein the saw blade further comprises a coating comprising diamond crystals; and wherein the diamond crystals have an edge length within the range from 1 μm to 25 μm.

14. The cutting tool of claim 13 wherein the saw blade comprises a plurality of saw teeth formed by the diamond crystals; and wherein the plurality of saw teeth have a maximum depth of 4 μm.

15. A cutting tool comprising:
a housing;
an adapter carried by the housing configured to receive and carry at least one of a connector and a ferrule;
a slide;
a saw assembly carried by the slide and comprising:
a motor bracket,
a first motor attached to the motor bracket and
a saw blade formed from a cemented tungsten carbide material having a grain size within the range from 0.8 μm to 1.4 μm and including a cobalt composition within the range from 0% to 10%, and
a hub connected to each of the first motor and the saw blade and configured to transmit rotation from the first motor to the saw blade;
a second motor operably connected to the slide;
a controller connected to and configured to control the operation of each of the first motor and the second motor; and
a power source electrically connected to each of the first motor, the second motor, and the controller;
wherein the first motor is operable to rotate the saw blade; and
wherein the second motor is operable to translate the saw blade along a cutting path so as to interface with and cut at least one of a ferrule, a fiber, and an epoxy bead of the connector or the ferrule carried by the adapter.

16. The cutting tool of claim 15 wherein the saw blade further comprises a coating comprising diamond crystals; and wherein the diamond crystals have an edge length within the range from 1 μm to 25 μm.

17. The cutting tool of claim 15 wherein the tungsten carbide material is a cemented tungsten carbide material having a grain size of 1.2 μm and including a cobalt composition of 6%.

18. The cutting tool of claim 15 further comprising a return extension spring attached to the saw assembly and the housing and configured to exert a return force on the saw assembly when the second motor translates the saw blade.

19. The cutting tool of claim 18 further comprising a spring adjust slide; wherein the return extension spring is attached to the spring adjust slide; and wherein a magnitude of the return force exerted by the return extension spring is adjustable by adjusting the spring adjust slide.

20. A cutting tool comprising:
a housing;
an adapter carried by the housing configured to receive and carry at least one of a connector and a ferrule;
a slide;
a saw assembly carried by the slide and comprising:
a motor bracket,
a first motor attached to the motor bracket and
a saw blade formed of a material selected from the group consisting of tungsten, tungsten carbide, tungsten carbide including a nickel binder, tungsten carbide including a cobalt binder, tungsten alloy, single crystal silicon, sintered silicon carbide, silicon carbide, single crystal silicon carbide, and molybdenum and comprising a coating comprising diamond crystals having an edge length within the range from 1 μm to 25 μm, and a hub connected to each of the first motor and the saw blade and configured to transmit rotation from the first motor to the saw blade;
a second motor operably connected to the slide;
a controller connected to and configured to control the operation of each of the first motor and the second motor;
a power source electrically connected to each of the first motor, the second motor, and the controller; and
a return extension spring attached to the saw assembly and the housing and configured to exert a return force on the saw assembly when the second motor translates the saw blade;
wherein the first motor is operable to rotate the saw blade; and
wherein the second motor is operable to translate the saw blade along a cutting path of the saw blade so as to interface with and cut at least one of a ferrule, a fiber, and an epoxy bead of a connector or ferrule carried by the adapter.
